(19) United States
(12) Patent Application Publication
(10) Pub. No.: US 2013/0246847 A1
(43) Pub. Date: Sep. 19, 2013

(54) METHOD OF DETECTING ERROR IN WRITE DATA AND DATA PROCESSING SYSTEM TO PERFORM THE METHOD

(71) Applicant: SAMSUNG Electronics Co., Ltd., Suwon-si (KR)

(72) Inventor: Bum Seok YU, Suwon-si (KR)

(73) Assignee: SAMSUNG Electronics Co., Ltd., Suwon-si (KR)

(21) Appl. No.: 13/799,609

(22) Filed: Mar. 13, 2013

(30) Foreign Application Priority Data
Mar. 19, 2012 (KR) 10-2012-0027512

(51) Int. Cl. G06F 11/08

(52) U.S. Cl. CPC G06F 11/08
USPC 714/18; 714/57

(57) ABSTRACT

A method of detecting an error in write data includes generating first error detection data based on first write data to be written to a buffer memory, generating second error detection data based on second write data related with the first write data, comparing the first error detection data with the second error detection data, and generating an error detection signal according to a comparison result.

### CROSS-REFERENCE TO RELATED APPLICATIONS

This application claims priority under 35 U.S.C. § 119(a) from Korean Patent Application No. 10-2012-0027512 filed on Mar. 19, 2012, the disclosure of which is hereby incorporated by reference in its entirety.

### BACKGROUND

1. Field

Embodiments of the inventive concept relate to an error detection system, and more particularly, to a method of detecting an error in write data during a write operation and a data processing system to perform the method.

2. Description of the Related Art

When data is transmitted between a central processing unit (CPU) and a peripheral device, there is a difference in a data transmission rate between the CPU and the peripheral device.

A buffer memory is a device that temporarily stores the data to make up for the difference in the data transmission rate. A cache memory is a high-speed memory embedded in a fundamental processing device of a workstation or a medium- or large-size computer.

Both the buffer memory and the cache memory are intermediate data storage. However, the cache memory is used to increase an operation speed while the buffer memory is used to transfer data between a plurality of operations. In other words, the buffer memory is used to transfer data between devices or programs having different data processing speeds, different data processing units, or different data using times. In addition, the buffer memory may be shared by hardware having different data processing speeds or processes of programs having different priorities.

In general, error detection on data stored in the buffer memory is performed during a read operation of the buffer memory. However, when another operation is performed after the read operation, data having an error may not be recovered.

### SUMMARY OF THE INVENTION

The present general inventive concept provides an apparatus and method of detecting an error on data in a data processing system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of detecting an error in write data. The method includes generating first error detection data based on first write data to be written to a buffer memory by using a buffer memory controller, generating second error detection data based on second write data related with the first write data by using an error detection circuit, and comparing the first error detection data with the second error detection data, and generating an error detection signal according to a comparison result by using the error detection circuit.

The second write data may be output from the buffer memory controller. Alternatively, the second write data may be read from the buffer memory. As another alternative, the second write data may be fed back from an input/output interface connected between the buffer memory controller and the buffer memory.

The buffer memory controller, the buffer memory, and the error detection circuit may be implemented in one chip. Alternatively, the error detection circuit and the buffer memory may be implemented in different chips, respectively.

The method may further include retransmitting the first write data to the buffer memory in response to the error detection signal by using the buffer memory controller. The first error detection data and the second error detection data may include parity bits.

The foregoing and/or other features and utilities of the present general inventive concept may also be achieved by providing a data processing system including a buffer memory controller configured to generate first error detection data based on first write data to be written to a buffer memory, and an error detection circuit configured to generate second error detection data based on second write data related with the first write data, compare the first error detection data with the second error detection data, and generate an error detection signal according to a comparison result.

The error detection circuit may include an error data generating circuit configured to generate the second error detection data based on the second write data and a comparison circuit configured to compare the first error detection data with the second error detection data and generate the error detection signal.

The error detection signal generated when the first error detection data is different from the second error detection data may indicate that the first write data is changed into the second write data different from the first write data while the first write data is being transmitted to the buffer memory. The error detection signal generated when the first error detection data is same as the second error detection data may indicate that the second write data same as the first write data is transmitted to the buffer memory.

The buffer memory controller may retransmit the first write data to the buffer memory in response to the error detection signal.

The data processing system may further include a processor configured to generate a control signal in response to the error detection signal. At this time, the buffer memory controller may retransmit the first write data to the buffer memory in response to the control signal. The data processing system may be implemented as a system on chip.

The foregoing and/or other features and utilities of the present general inventive concept may also be achieved by providing a computer-readable medium to contain computer-readable codes as a program to execute the above-described method.

The foregoing and/or other features and utilities of the present general inventive concept may also be achieved by providing a method of detecting an error in write data in a data processing system, the method including detecting an error in write data when the write data is transmitted to a buffer memory, and determining whether to retransmit the write data to the buffer memory according to the error detection result.

The detecting operation may include generating first error detection data based on first write data using a buffer memory controller, generating second error detection data based on second write data output from the buffer memory controller, and comparing the first error detection data with the second error detection data to generate an error detection signal as the error detection result.

The determining operation may include transmitting the error detection signal to at least one of the buffer memory controller and a processor to process an operation using the write data.

The detecting operation may include generating error detection data based on the write data using a buffer memory controller, generating another error detection data based on another write data output from the buffer memory controller, comparing the error detection data with the another error detection data to generate an error detection signal, and generating feedback write data from the another write data to be transmitted to the buffer memory controller, such that the buffer memory controller reprocess the write data to be stored in a buffer memory according to the error detection result of the error detection signal and the feedback write data.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a data processing system according to an embodiment of the inventive concept;

FIG. 2 is a block diagram illustrating an operation of the data processing system of FIG. 1 with a controller including a buffer memory controller and a first error detection circuit according to an exemplary embodiment of the present general inventive concept;

FIG. 3 is a block diagram illustrating an operation of the data processing system of FIG. 1 with a controller including a buffer memory controller, a processor, and a first error detection circuit according to an exemplary embodiment of the present general inventive concept;

FIG. 4 is a block diagram illustrating an operation of the data processing system of FIG. 1 with a controller including an internal buffer memory, a buffer memory controller, and a second error detection circuit according to an exemplary embodiment of the present general inventive concept;

FIG. 5 is a block diagram illustrating an operation of the data processing system of FIG. 1 with a controller including an internal buffer memory, a buffer memory controller, a processor, and a second error detection circuit according to an exemplary embodiment of the present general inventive concept;

FIG. 6 is a block diagram illustrating a data processing system according to an embodiment of the inventive concept;

FIG. 7 is a block diagram illustrating an operation of the data processing system of FIG. 6 with a controller including a buffer memory controller, an input/output (I/O) interface, and a first error detection circuit according to an exemplary embodiment of the inventive concept;

FIG. 8 is a block diagram illustrating an operation of the data processing system of FIG. 6 with a controller including a buffer memory controller, an I/O interface, and a first error detection circuit according to an exemplary embodiment of the inventive concept;

FIG. 9 is a block diagram illustrating an operation of the data processing system of FIG. 6 with a controller including a buffer memory controller, an I/O interface, and a first error detection circuit according to an exemplary embodiment of the inventive concept;

FIG. 10 is a schematic flowchart illustrating a method of the data processing system of FIG. 1 or 6 according to an exemplary embodiment of the present general inventive concept;

FIG. 11 is a flowchart illustrating a method of the data processing system of FIG. 1 or 6 according to an exemplary embodiment of the inventive concept; and

FIG. 12 is a flowchart illustrating a method of the data processing system of FIG. 1 or 6 according to an exemplary embodiment of the inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the present general inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present general inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

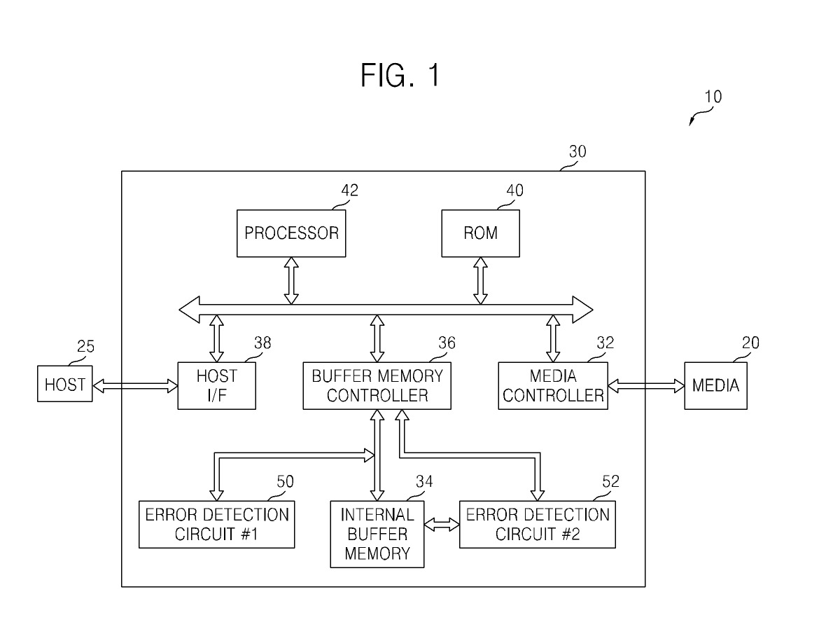

FIG. 1 is a block diagram illustrating a data processing system 10 according to an embodiment of the inventive concept. The data processing system 10 includes a media 20, a host 25, and a controller 30.

The data processing system 10 may be implemented as a personal computer (PC), a data server, or a portable device. The portable device may be a laptop computer, a mobile phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, or an e-book.

The media 20 may be a storage device to store data. It may be implemented by a hard disk, a volatile memory device, or a non-volatile memory device.

The non-volatile memory device may be implemented by electrically erasable programmable read-only memory (EEPROM), flash memory, magnetic random access memory (MRAM), spin-transfer torque MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, molecular electronic memory device, or insulator resistance change memory.

The controller 30 may control data communication (transmission) between the media 20 and the host 25. The controller 30 includes a media controller 32, an internal buffer memory 34, a buffer memory controller 36, a host interface (I/F) 38, ROM 40, a processor 42, and a first error detection circuit 50. The controller 30 may also include a second error detection circuit 52.

The media controller 32 may control an access to the media 20. For instance, the media controller 32 may control a write operation of writing data to the media 20 or a read operation of reading data from the media 20.

The internal buffer memory 34 may buffer data transmitted between the host 25 and the media 20. The internal buffer memory 34 may be implemented by static RAM (SRAM) or embedded dynamic RAM (DRAM). The buffer memory controller 36 may control an access to the internal buffer memory 34. For instance, the buffer memory controller 36 may control a write operation of writing data to the internal buffer memory 34 or a read operation of reading data from the internal buffer memory 34.

The host I/F 38 may interface data signals transmitted between the host 25 and the controller 30. The ROM 40 may store data necessary for the operation of the processor 42 and/or an operation of the data processing system 10 and may be implemented using various types of non-volatile memories. The processor 42 may control the overall operation of the controller 30.

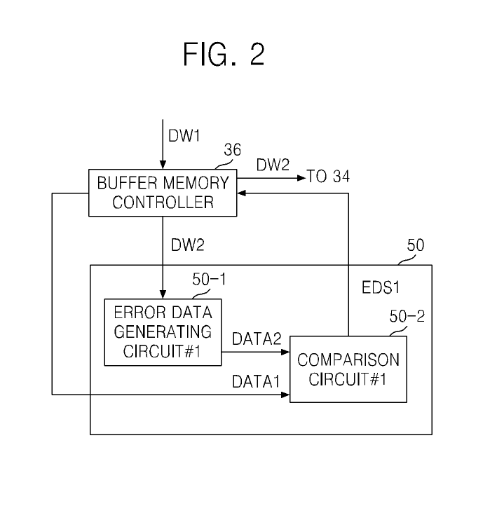

The first error detection circuit 50 may receive write data from the buffer memory controller 36 and detect an error in the write data based on the write data. The second error detection circuit 52 may detect an error in the write data based on write data output from the internal buffer memory 34. The structures and the operations of the first and second error detection circuits 50 and 52 will be described in detail with reference to FIGS. 2 through 5.

During the write operation of the data processing system 10, write data output (or received) from the host 25 is stored in the internal buffer memory 34 via the host I/F 38 and the buffer memory controller 36. Thereafter, the write data may be read from the internal buffer memory 34 according to the control of the buffer memory controller 36 and then written to the media 20 through the media controller 32. At this time, the write data output from the host 25 may be changed according to a characteristic of the data communication, for example, a frequency characteristic and/or a voltage characteristic of the buffer memory controller 36.

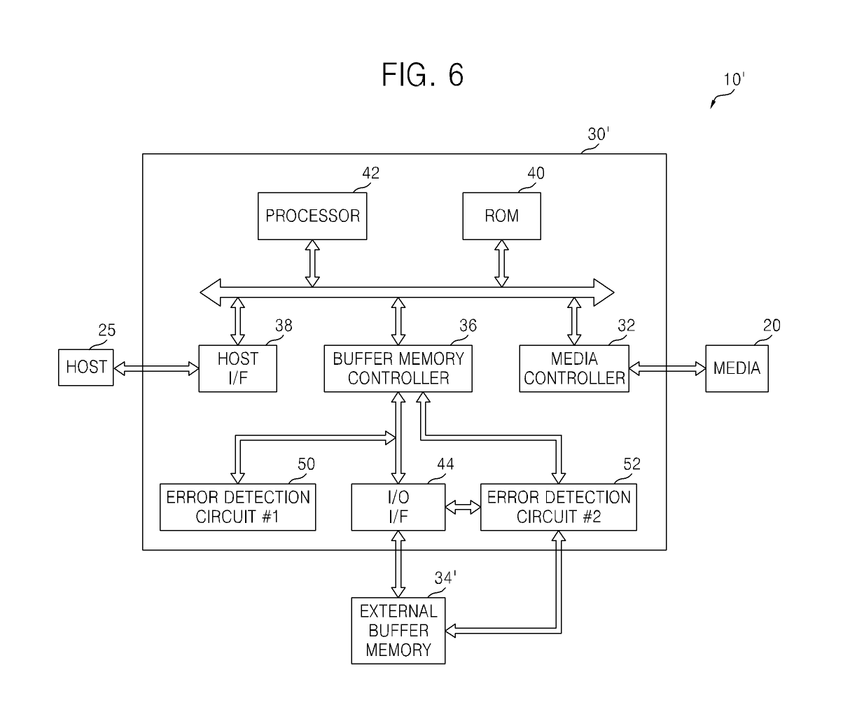

The write data output from the buffer memory controller 36 may be changed according to a characteristic of the data processing system 10 and/or a communication with an external device, for example, the characteristic, e.g., noise, of interface between the buffer memory controller 36 and the internal buffer memory 34. It is possible that the data written to the internal buffer memory 34 may be changed according to the operating characteristic of the internal buffer memory 34, e.g., operating voltage or coupling between memory cells. Technological ideas of the inventive concept are to provide a method of quickly detecting write data that has been changed by those characteristics. The controller 30 and/or the media 20 may be formed as a system on chip. It is possible that the controller 30, the media 20, and/or an external buffer memory 34′ of FIG. 6 may be formed as a system on chip.

FIG. 2 is a block diagram illustrating an operation of the data processing system 10 of FIG. 1 according to an exemplary embodiment of the present general inventive concept. FIG. 2 illustrates the controller 30 including the buffer memory controller 36 and the first error detection circuit 50 as illustrated in FIG. 1. Referring to FIGS. 1 and 2, the first error detection circuit 50 includes a first error data generating circuit 50-1 and a first comparison circuit 50-2.

The first error data generating circuit 50-1 may generate second error detection data DATA2 according to detection of an error in second write data DW2. The first error data generating circuit 50-1 may generate parity bits for the second write data DW2. The first error data generating circuit 50-1 may generate parity bits using an error correction code (ECC) and generate the second error detection data DATA2 including the parity bits.

It is possible that the first error data generating circuit 50-1 may generate parity bits using cyclic redundancy check (CRC) and generate the second error detection data DATA2 including the parity bits. It is also possible that the first error data generating circuit 50-1 may use a different error detection algorithm to detect an error in the second write data DW2.

The buffer memory controller 36 may transmit the second write data DW2 corresponding to first write data DW1 that has been transmitted to, received by, and/or stored in the internal buffer memory 34 or the first error detection circuit 50.

When no error occurs in the first write data DW1 while the first write data DW1 is being processed by the buffer memory controller 36, the second write data DW2 output from the buffer memory controller 36 is the same as the first write data DW1. However, when an error occurs while the first write data DW1 is being processed by the buffer memory controller 36, the second write data DW2 output from the buffer memory controller 36 is different from the first write data DW1.

The buffer memory controller 36 generates parity bits, i.e., first error detection data DATA1, according to detection of an error in the first write data DW1 based on the first write data DW1. The buffer memory controller 36 may include an error data generating circuit (not illustrated) to generate the first error detection data DATA1. The error data generating circuit may generate the first error detection data DATA1 using an ECC or CRC.

The first error detection circuit 50 may receive the second write data DW2 and the first error detection data DATA1 from the buffer memory controller 36.

The first error data generating circuit 50-1 may generate parity bits, i.e., the second error detection data DATA2 according to a determination on the detection of an error in the second write data DW2 based on the second write data DW2. The first error detection data DATA1 and the second error detection data DATA2 may include parity bits generated using, for example, an ECC or CRC.

The first comparison circuit 50-2 may compare the first error detection data DATA1 with the second error detection data DATA2 and generate an error detection signal EDS1 according to a result of the comparison. For instance, when the first error detection data DATA1 is the same as the second error detection data DATA2, the first comparison circuit 50-2 may generate the error detection signal EDS1 having a first value, e.g., logic “0”. However, when the first error detection data DATA1 is different from the second error detection data DATA2, the first comparison circuit 50-2 may generate the error detection signal EDS1 having a second value, e.g., logic “1”.

The first comparison circuit 50-2 may compare the first error detection data DATA1 with the second error detection data DATA2 bit by bit to find out whether they are the same. It is possible that the first comparison circuit 50-2 may calculate the number of bits different between the parity bits included in the first error detection data DATA1 and the parity bits included in the second error detection data DATA2.

The buffer memory controller 36 may rewrite the first write data DW1 to the internal buffer memory 34 based on the error detection signal EDS1 having the second value.

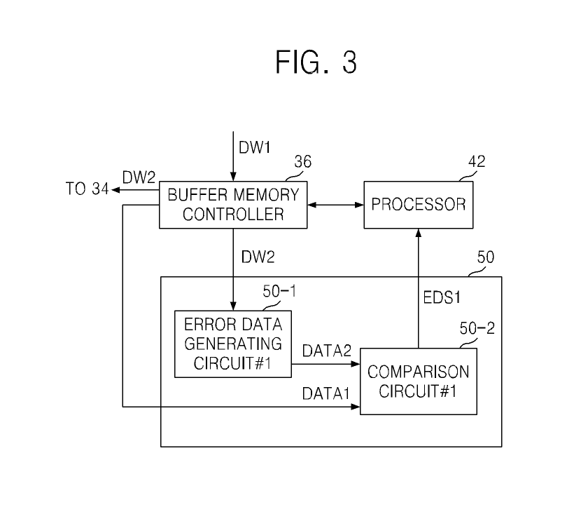

FIG. 3 is a block diagram illustrating an operation of the data processing system 10 of FIG. 1 according to an exemplary embodiment of the present general inventive concept. FIG. 3 illustrates the controller 30 including the buffer memory controller 36, the processor 42, and the first error detection circuit 50 as illustrated in FIG. 1. Referring to FIGS. 2 and 3, the structure and the operation of the first error detection circuit 50 illustrated in FIG. 3 is substantially the same as those of the first error detection circuit 50 illustrated in FIG. 2, with the exception that the error detection signal EDS1 is provided to the processor 42.

The processor 42 may generate a control signal in response to the error detection signal EDS1. The processor 42 may stop a current operation and/or an operation of a peripheral device (not illustrated) in response to the error detection signal EDS1. The buffer memory controller 36 may rewrite the first write data DW1 to the internal buffer memory 34 in response to the control signal output from the processor 42. The error detection signal EDS1 may be stored in a status register (not illustrated) included in the processor 42. The error detection signal EDS1 may be used as an index indicating whether the first write data DW1 has an error.

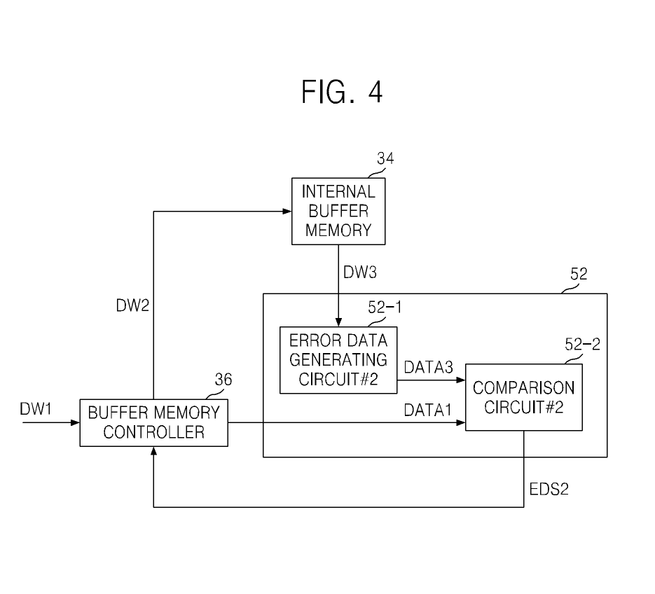

FIG. 4 is a block diagram illustrating an operation of the data processing system 10 of FIG. 1 according to an exemplary embodiment of the present general inventive concept. FIG. 4 illustrates the controller 30 including the internal buffer memory 34, the buffer memory controller 36, and the second error detection circuit 52 illustrated in FIG. 1. The second error detection circuit 52 includes a second error data generating circuit 52-1 and a second comparison circuit 52-2.

The buffer memory controller 36 may transmit the second write data DW2 corresponding to the received first write data DW1 to the internal buffer memory 34. As described above, the first write data DW1 may be the same as or different from the second write data DW2 depending on whether an error occurs while the first write data DW1 is being processed by the buffer memory controller 36. The buffer memory controller 36 generates the first error detection data DATA1 for the detection of an error in the first write data DW1 based on the first write data DW1.

The second error detection circuit 52 may receive third write data DW3 from the internal buffer memory 34. As mentioned above, the second write data DW2 written to the internal buffer memory 34 may be changed according to the operating characteristic of the internal buffer memory 34. An operation of the second error detection circuit 52 reading the third write data DW3 may be performed before another operation is performed after the second write data DW2 is written to the internal buffer memory 34.

The second error data generating circuit 52-1 may generate parity bits, i.e., third error detection data DATA3, which is used to detect an error in the third write data DW3, based on the third write data DW3. The third error detection data DATA3 may be ECC data or CRC data.

The second comparison circuit 52-2 may compare the first error detection data DATA1 with the third error detection data DATA3 and generate an error detection signal EDS2 according to a result of the comparison.

When the first through third write data DW1, DW2, and DW3 are the same, the second error data generating circuit 52-1 may generate the third error detection data DATA3 which is the same as the first error detection data DATA1. It is possible that the second error data generating circuit 52-1 may generate the third error detection data DATA3 different from the first error detection data DATA1.

When the first error detection data DATA1 is the same as the third error detection data DATA3, the second comparison circuit 52-2 may generate the error detection signal EDS2 having the first value. However, when the first error detection data DATA1 is different from the third error detection data DATA3, the second comparison circuit 52-2 may generate the error detection signal EDS2 having the second value.

The second comparison circuit 52-2 may compare the first error detection data DATA1 with the third error detection data DATA3 bit by bit to find out whether they are the same. It is possible that the second comparison circuit 52-2 may calculate the number of bits different between the parity bits included in the first error detection data DATA1 and the parity bits included in the third error detection data DATA3.

The buffer memory controller 36 may rewrite the first write data DW1 to the internal buffer memory 34 in response to the error detection signal EDS2 having the second value.

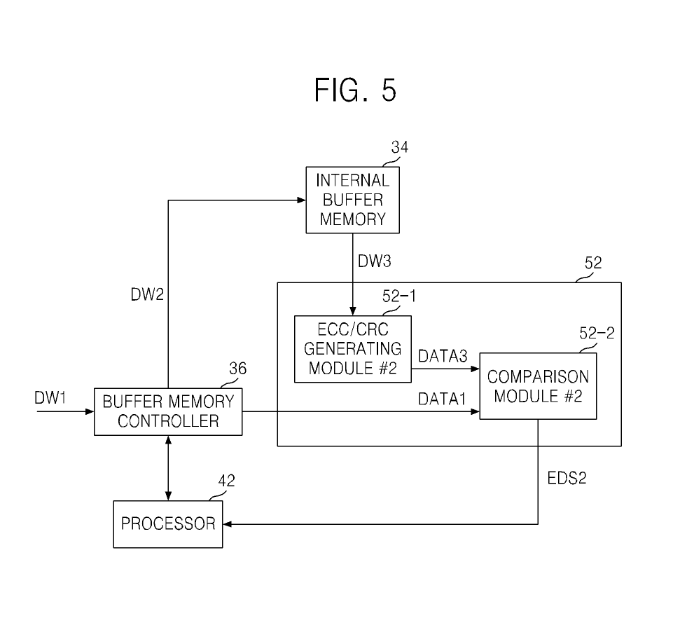

FIG. 5 is a block diagram illustrating an operation of the data processing system 10 of FIG. 1 according to an exemplary embodiment of the present general inventive concept. FIG. 5 illustrates the controller 30 including the internal buffer memory 34, the buffer memory controller 36, the processor 42, and the second error detection circuit 52 illustrated in FIG. 1. Referring to FIGS. 4 and 5, the structure and the operation of the second error detection circuit 52 illustrated in FIG. 5 is substantially the same as those of the second error detection circuit 52 illustrated in FIG. 4, with the exception that the error detection signal EDS2 is provided to the processor 42.

The processor 42 may generate a control signal in response to the error detection signal EDS2. The processor 42 may stop a current operation and/or an operation of a peripheral device (not illustrated) in response to the error detection signal EDS2. The buffer memory controller 36 may rewrite the first write data DW1 to the internal buffer memory 34 in response to the control signal output from the processor 42.

The error detection signal EDS2 may be stored in a status register (not illustrated) included in the processor 42. The error detection signal EDS2 may be used as an index indicating whether the first write data DW1 has an error.

FIG. 6 is a block diagram illustrating a data processing system 10′ according to an embodiment of the inventive concept. Referring to FIGS. 1 and 6, the structure and the operation of the data processing system 10′ of FIG. 6 are substantially the same as those of the data processing system 10 of FIG. 1, with the exception that an external buffer memory 34′ and an input/output (I/O) I/F 44 are further provided. It is possible that the internal buffer memory 34 of FIG.1 can be replaced by the external buffer memory 34′ of FIG. 6.

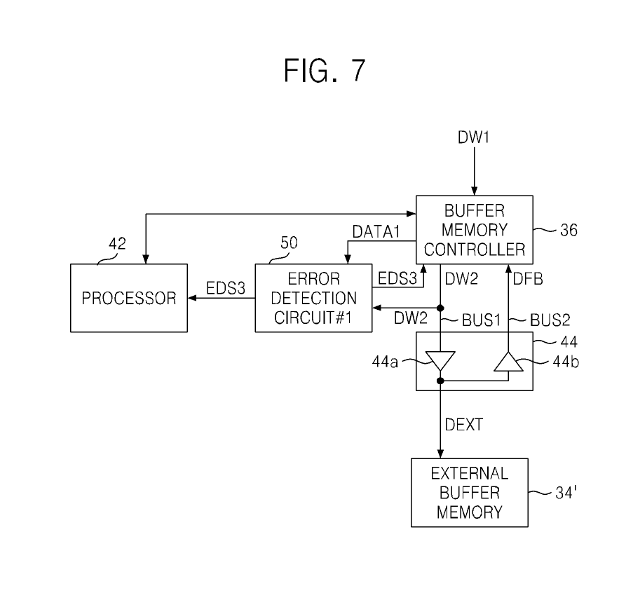

The external buffer memory 34′ may be implemented by a volatile memory device such as SRAM or DRAM or a non-volatile memory device. The I/O I/F 44 may interface data between the buffer memory controller 36 and the external buffer memory 34′. The structure and the operation of the I/O I/F 44 and the first error detection circuit 50 will be described in detail with reference to FIGS. 7 through 9.

FIG. 7 is a block diagram illustrating an operation of the data processing system 10′ of FIG. 6 according to an exemplary embodiment of the present general inventive concept. FIG. 7 illustrates a controller 30′ including the buffer memory controller 36, the I/O I/F 44, and the first error detection circuit 50 as illustrated in FIG. 6, according to an exemplary embodiment of the inventive concept. Referring to FIGS. 2, 3, 6, and 7, the I/O I/F 44 includes an output buffer 44a and a feedback buffer 44b.

The output buffer 44a may buffer the second write data DW2. The feedback buffer 44b may buffer buffered write data DEXT. The output buffer 44a and the feedback buffer 44b may operate during the write operation of the buffer memory controller 36.

The buffer memory controller 36 may transmit the second write data DW2 to the I/O I/F 44 and/or the first error detection circuit 50.

The second write data DW2 may be transmitted to the I/O I/F 44 through a first bus BUS1. The output buffer 44a of the I/O I/F 44 may output the second write data DW2 as the buffered write data DEXT. The feedback buffer 44b of the I/O I/F 44 may feedback the buffered write data DEXT to the buffer memory controller 36 as feedback write data DFB. At this time, the feedback write data DFB may be fed back through a second bus BUS2.

The buffered write data DEXT may be data that will be written to the external buffer memory 34′. The feedback write data DFB may be data for detecting error of the buffered write data DEXT.

The first error detection circuit 50 may transmit an error detection signal EDS3 at least one of the buffer memory controller 36 and the processor 42. Accordingly, apart from the objects 36 and 42 to which the error detection signal EDS3 is provided, the structure of the first error detection circuit 50 illustrated in FIG. 7 is substantially the same as the first error detection circuit 50 illustrated in FIG. 2. The first error detection circuit 50 may detect whether an error is in the second write data DW2 according to a result of comparing the first error detection data DATA1 output from the buffer memory controller 36 with the second error detection data DATA2 generated based on the second write data DW2.

The buffer memory controller 36 may determine whether to retransmit the first write data DW1 to the external buffer memory 34′ based on the error detection signal EDS3.

The processor 42 may control the buffer memory controller 36 based on the error detection signal EDS3. At this time, the buffer memory controller 36 may determine whether to retransmit the first write data DW1 to the external buffer memory 34′ according to the control of the processor 42.

In addition, the buffer memory controller 36 may compare the first write data DW1 with the feedback write data DFB and determine whether the first write data DW1 has an error according to a result of the comparison. For instance, even when the error detection signal EDS3 output from the first error detection circuit 50 has the first value, if the parity bits of the first write data DW1 are different from the parity bits of the feedback write data DFB, the buffer memory controller 36 may retransmit the first write data DW1 to the external buffer memory 34′ via the I/O I/F 44.

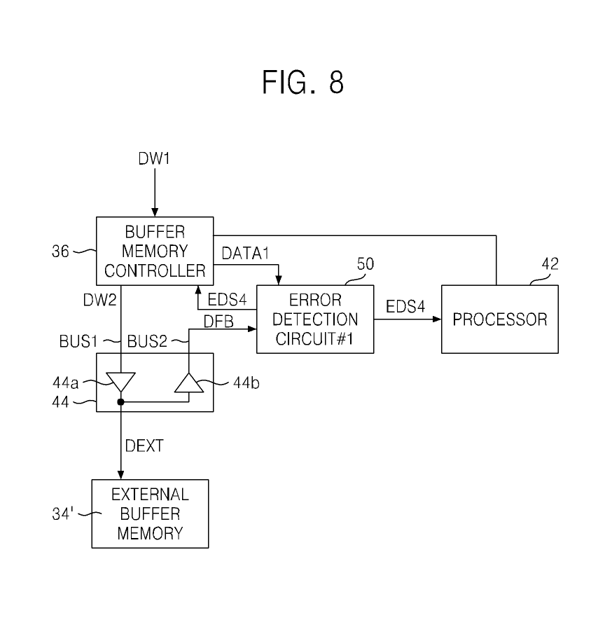

FIG. 8 is a block diagram illustrating an operation of the data processing system, 10′ of FIG. 6 according to an exemplary embodiment of the present general inventive concept. FIG. 8 illustrates the controller 30′ including the buffer memory controller 36, the I/O I/F 44, and the first error detection circuit 50 as illustrated in FIG. 6, according to an exemplary embodiment of the inventive concept. Referring to FIGS. 2 and 8, the first error detection circuit 50 may detect whether the feedback write data DFB has an error according to a result of comparing the first error detection data DATA1 output from the buffer memory controller 36 with the second error detection data DATA2 generated based on the feedback write data DFB.

At this time, the first error data generating circuit 50-1 illustrated in FIG. 2 may generate the second error detection data DATA2 based on the feedback write data DFB. The first comparison circuit 50-2 illustrated in FIG. 2 generates an error detection signal EDS4 (=EDS1) according to a result of the comparison between the first error detection data DATA1 and the second error detection data DATA2. As described above, the data DW2 and DFB may be changed according to the characteristics of the I/O I/F 44.

When the write data DW1, DW2, and DFB are the same, the first comparison circuit 50-2 illustrated in FIG. 2 may generate the error detection signal EDS4 (=EDS1) having the first value. In otherwise cases, the first comparison circuit 50-2 illustrated in FIG.2 may generate the error detection signal EDS4 (=EDS1) having the second value.

The buffer memory controller 36 may determine whether to retransmit the first write data DW1 to the external buffer memory 34′ based on the error detection signal EDS4 having the second value. When the error detection signal EDS4 having the second value is provided to the processor 42, the processor 42 may control the buffer memory controller 36 based on the error detection signal EDS4. Accordingly, the buffer memory controller 36 may determine whether to retransmit the first write data DW1 to the external buffer memory 34′ according to the control of the processor 42.

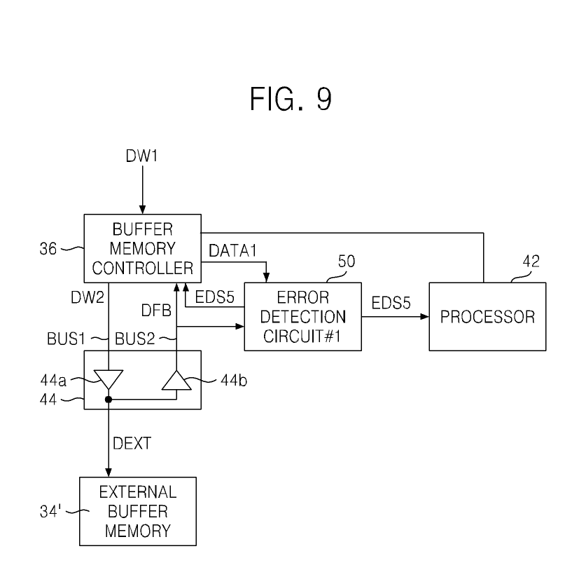

FIG. 9 is a block diagram illustrating an operation of the data processing system 10′ of FIG. 6 according to an exemplary embodiment of the present general inventive concept. FIG. 9 illustrates the controller 30′ including the buffer memory controller 36, the I/O I/F 44, and the first error detection circuit 50 as illustrated in FIG. 6, according to an exemplary embodiment of the inventive concept.

Referring to FIGS. 2 and 9, the first error detection circuit 50 may detect whether the feedback write data DFB has an error according to a result of comparing the first error detection data DATA1 output from the buffer memory controller 36 with the second error detection data DATA2 generated based on the feedback write data DFB. At this time, the first error data generating circuit 50-1 illustrated in FIG. 2 may generate the second error detection data DATA2 based on the feedback write data DFB.

The first comparison circuit 50-2 illustrated in FIG. 2 generates an error detection signal EDS5 (=EDS1) according to a result of the comparison between the first error detection data DATA1 and the second error detection data DATA2.

As described above, the data DW2 and DFB may be changed according to a characteristic of the data processing system 10′, for example, one or more characteristics of the I/O I/F 44. When the write data DW1, DW2, and DFB are the same, the first comparison circuit 50-2 illustrated in FIG. 2 may generate the error detection signal EDS5 (=EDS1) having the first value. It is possible that the first comparison circuit 50-2 may generate the error detection signal EDS5 (=EDS1) having the second value.

The buffer memory controller 36 may determine whether to retransmit the first write data DW1 to the external buffer memory 34′ based on the error detection signal EDS5 having the second value.

When the error detection signal EDS5 having the second value is provided to the processor 42, the processor 42 may control the buffer memory controller 36 based on the error detection signal EDS5. Accordingly, the buffer memory controller 36 may determine whether to retransmit the first write data DW1 to the external buffer memory 34′ according to the control of the processor 42.

The buffer memory controller 36 may compare parity bits for the first write data DW1 with parity bits for the feedback write data DFB and determine whether the feedback write data DFB has an error based on a result of the comparison. For instance, even though the error detection signal EDS5 output from the first error detection circuit 50 has the first value, when the parity bits for the first write data DW1 are different from the parity bits for the feedback write data DFB, the buffer memory controller 36 may retransmit the first write data DW1 to the external buffer memory 34′ via the I/O I/F 44.

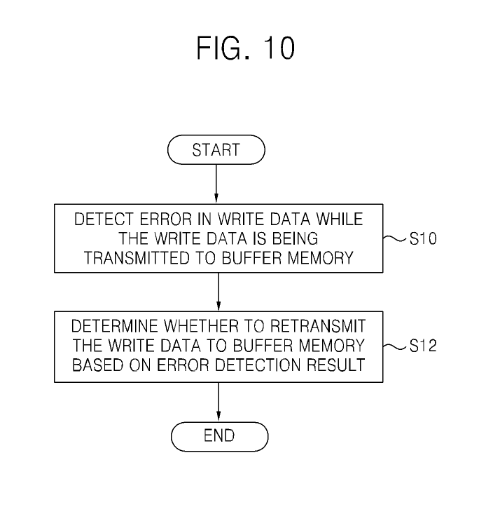

FIG. 10 is a schematic flowchart illustrating a method of the data processing system 10 or 10′ illustrated in FIG. 1 or 6 according to an exemplary embodiment of the present general inventive concept. Referring to FIGS. 1 through 10, while the write data DW1, DW2, or DEXT is being transmitted to the buffer memory 34 or 34′, the first error detection circuit 50 detects an error in the write data DW1, DW2, or DEXT in operation S10.

The buffer memory controller 36 determines whether to retransmit the write data DW1 to the buffer memory 34 or 34′ based on an error detection result, e.g., the error detection signal EDS1, EDS3, EDS4, or EDS5, in operation S12.

Alternatively, when the buffer memory controller 36 operates according to the control of the processor 42, as shown in FIGS. 3, 7, 8, and 9, the buffer memory controller 36 may determine whether to retransmit the write data DW1 to the buffer memory 34 or 34′ based on a control signal output from the processor 42.

As described above, the buffer memory controller 36 may determine whether to retransmit the write data DW1 to the buffer memory 34 or 34′ independently or according to the control of the processor 42.

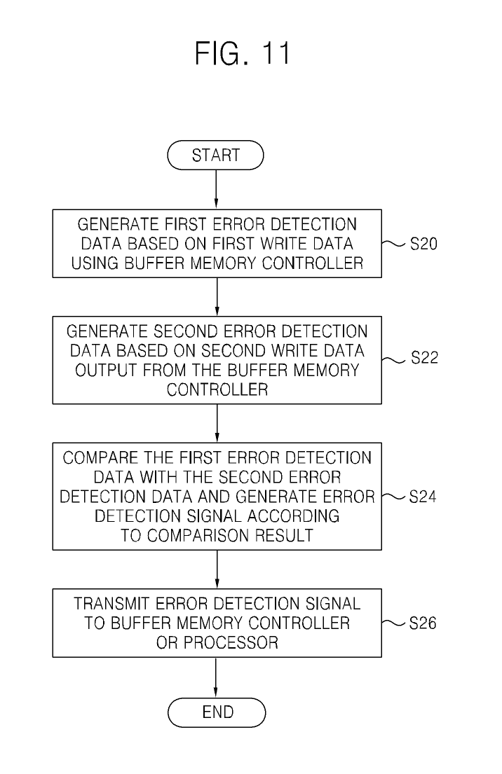

FIG. 11 is a detailed flowchart illustrating a method of the data processing system 10 or 10′ illustrated in FIG. 1 or 6 according to an embodiment of the inventive concept. Referring to FIGS. 1 through 3, FIGS. 6 through 9, and FIG. 11, the buffer memory controller 36 may generate the first error detection data DATA1 based on the first write data DW1 that has been received in operation S20.

The first error detection circuit 50 may receive the second write data DW2 output from the buffer memory controller 36 and generate the second error detection data DATA2 based on the second write data DW2 in operation S22. The first comparison circuit 50-2 may compare the first error detection data DATA1 with the second error detection data DATA2 and generate the error detection signal EDS1, EDS3, EDS4, or EDS5 according to a comparison result in operation S24.

The error detection signal EDS1, EDS3, EDS4, or EDS5 may be transmitted to the buffer memory controller 36 or the processor 42 in operation S26.

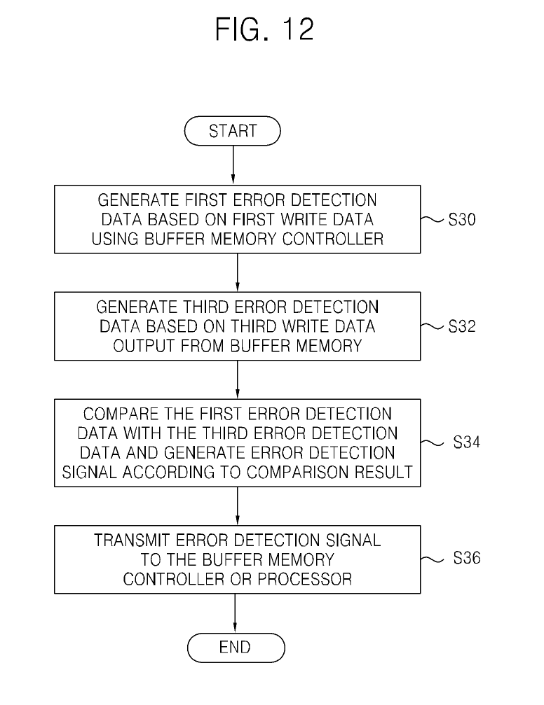

FIG. 12 is a detailed flowchart illustrating a method of the data processing system 10 or 10′ illustrated in FIG. 1 or 6 according to an embodiment of the inventive concept. Referring to FIGS. 1, 4, 5, 6, and 12, the buffer memory controller 36 may generate the first error detection data DATA1 based on the first write data DW1 that has been received in operation S30. The second error detection circuit 52 may receive the third write data DW3 output from the buffer memory 34 or 34′ and generate the third error detection data DATA3 based on the third write data DW3 in operation S32.

The second comparison circuit 52-2 may compare the first error detection data DATA1 with the third error detection data DATA3 and generate the error detection signal EDS2 according to a comparison result in operation S34. The error detection signal EDS2 may be transmitted to the buffer memory controller 36 or the processor 42 in operation S36.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to some embodiments of the inventive concept, an error is detected in write data during a write operation, thereby increasing the efficiency of error detection and the integrity of the write data.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of detecting an error in write data in a data processing system, the method comprising:
generating first error detection data based on first write data to be written to a buffer memory by using a buffer memory controller;
generating second error detection data based on second write data related with the first write data by using an error detection circuit; and
comparing the first error detection data with the second error detection data and generating an error detection signal based on a comparison result by using the error detection circuit.

2. The method of claim 1, wherein the second write data is output from the buffer memory controller.

3. The method of claim 1, wherein the second write data is read from the buffer memory.

4. The method of claim 1, wherein the second write data is fed back from an input/output interface connected between the buffer memory controller and the buffer memory.

5. The method of claim 1, wherein the buffer memory controller, the buffer memory, and the error detection circuit are implemented in one chip.

6. The method of claim 1, wherein the error detection circuit and the buffer memory are implemented in different chips, respectively.

7. The method of claim 1, further comprising:
retransmitting the first write data to the buffer memory in response to the error detection signal by using the buffer memory controller.

8. The method of claim 1, wherein the first error detection data and the second error detection data include parity bits, respectively.

9. A data processing system comprising:
a buffer memory controller configured to generate first error detection data based on first write data to be written to a buffer memory; and
an error detection circuit configured to generate second error detection data based on second write data related with the first write data, compare the first error detection data with the second error detection data, and generate an error detection signal according to a comparison result.

10. The data processing system of claim 9, wherein the error detection circuit comprises:
an error data generating circuit configured to generate the second error detection data based on the second write data; and
a comparison circuit configured to compare the first error detection data with the second error detection data and generate the error detection signal,
wherein the first error detection data and the second error detection data include parity bits, respectively.

11. The data processing system of claim 9, wherein the error detection signal generated when the first error detection data is different from the second error detection data indicates that the first write data is changed into the second write data different from the first write data while the first write data is being transmitted to the buffer memory.

12. The data processing system of claim 9, wherein the error detection signal generated when the first error detection data is same as the second error detection data indicates that the second write data is the same as the first write data is transmitted to the buffer memory.

13. The data processing system of claim 9, wherein the buffer memory controller retransmits the first write data to the buffer memory in response to the error detection signal.

14. The data processing system of claim 9, further comprising a processor configured to generate a control signal in response to the error detection signal, wherein the buffer memory controller retransmits the first write data to the buffer memory in response to the control signal.

15. The data processing system of claim 9, wherein the data processing system is a system on chip.

16. A non-transitory computer-readable medium to contain computer-readable codes as a program to execute the method of claim 1.

17. A method of detecting an error in write data in a data processing system, the method comprising:
detecting an error in write data when the write data is transmitted to a buffer memory; and
determining whether to retransmit the write data to the buffer memory according to the error detection result.

18. The method of claim 17, wherein the detecting comprises:
generating first error detection data based on first write data using a buffer memory controller;
generating second error detection data based on second write data output from the buffer memory controller; and
comparing the first error detection data with the second error detection data to generate an error detection signal as the error detection result.

19. The method of claim 18, wherein the determining comprises:
transmitting the error detection signal to at least one of the buffer memory controller and a processor to process an operation using the write data.

20. The method of claim 17, wherein the detecting comprises:
generating error detection data based on the write data using a buffer memory controller;
generating another error detection data based on feedback write data related with another write data output from the buffer memory controller;
comparing the error detection data with the another error detection data to generate an error detection signal.
